(19) United States
(12) Patent Application Publication
(10) Pub. No.: US 2021/0342469 A1
(43) Pub. Date: Nov. 4, 2021

(54) METHOD AND SYSTEM FOR PROVIDING MARKET DATA TO DISTRIBUTORS OR MANUFACTURERS

(71) Applicant: Orcatec LLC, Rancho Santa Fe, CA (US)

(72) Inventor: Alexei Golopapenko, Rancho Santa Fe, CA (US)

(21) Appl. No.: 16/864,752

(22) Filed: May 1, 2020

(51) Int. Cl. G06F 21/62; G06F 21/31; G06Q 30/02

(52) U.S. Cl. CPC G06F 21/6227; G06Q 30/0201; G06F 21/31; G06F 21/6236

(57) ABSTRACT

A system and method that provide market activity information about one or more dealers to a distributor or manufacture of equipment. The system comprises a hardware processor configured to obtain dealer information via a dealer communications device over a communications network. The dealer information being based on purchasing activity between the dealer and one or more distributors other than from the distributor. The system further comprises a memory device in communication with the hardware processor and configured to store the dealer information for later retrieval by the hardware processor. The hardware processor is further configured to authenticate the distributor based on credentials provided by the distributor. If the hardware processor determines that the credentials are valid, the hardware processor permits access by the distributor to view the dealer information.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

This disclosure relates to a communications network for allowing distributors and/or product manufacturers, to access market information about dealer equipment order activities.

### Description of the Related Art

Electronic transactions between service providers and recipients over the Internet and similar communications network have increased significantly in recent years. Dealers or contractors now transact business with their clients, such as scheduling, billing, payment, and follow-up, using electronic communications and platforms. In addition, those contractors conduct transactions (e.g., orders etc.) with equipment and product distributors and manufacturers electronically online. Those distributors and manufacturers do not have reliable data about the dealer or contractor business activities in a given market. There is a need for providing distributors and/or manufacturers with such information remotely over the communications network.

### SUMMARY OF THE INVENTION

In one embodiment, a system for providing information about one or more dealers to a distributor is provided. The system comprises a hardware processor configured to obtain dealer information via a dealer communications device over a communications network. The dealer information is based on purchasing activity between the dealer and one or more distributors other than the distributor. The system further comprises a memory device in communication with the hardware processor. The memory device is configured to store the dealer information for later retrieval by the hardware processor. The hardware processor is further configured to authenticate the distributor based on credentials provided by the distributor. If the hardware processor determines that the credentials are valid, the hardware processor is configured to permit access by the distributor to view the dealer information.

In another embodiment, a method of providing information about one or more dealers to a distributor is provided. The method comprises obtaining by a hardware processor dealer information via a dealer communications device over a communications network. The dealer information is based on purchasing activity between the dealer and one or more distributors other than the distributor. The method further comprises storing in a memory device the dealer information for later retrieval by the hardware processor. The method further comprises authenticating the distributor based on credentials provided by the distributor. The method further comprises, if the hardware processor determines that the credentials are valid, permitting access by the distributor to view the dealer information.

### BRIEF DESCRIPTION OF THE DRAWINGS

Embodiments of the above-mentioned aspects, as well as other features, aspects, and advantages of the present technology will now be described in connection with various aspects, with reference to the accompanying drawings. The illustrated aspects, however, are merely examples and are not intended to be limiting. Throughout the drawings, similar symbols typically identify similar components, unless context dictates otherwise. Note that the relative dimensions of the following figures may not be drawn to scale. The following drawings and the associated descriptions are provided to illustrate embodiments of the present disclosure and do not limit the scope of the claims.

FIG. 1 is a high-level block diagram of a communications system showing various network components in accordance with one embodiment of the invention.

FIG. 2 is a functional block diagram of the analytics system of the communications network of FIG. 1.

FIG. 3 is a functional block diagram of an exemplary distributor or manufacturer device of the communications network of FIG. 1.

FIG. 4 is a flowchart of an exemplary process of accessing information about dealer market transactions in accordance with one embodiment of the invention.

FIG. 5 is a flowchart describing a process of placing and monitoring progress of an order in accordance with one embodiment of the invention.

FIG. 6 is a screenshot of an exemplary page showing a list of dealer entities associated with a distributor in accordance with one embodiment of the invention.

FIG. 7 is a screenshot of an exemplary page showing sample proposal(s) of a dealer entity in accordance with one embodiment of the invention.

FIG. 8 is a screenshot of an exemplary page showing a sample order history made by a dealer entity in accordance with one embodiment of the invention,

FIG. 9 is a screenshot of an exemplary page showing a sample request for a price list initiated by a dealer entity to a distributor in accordance with one embodiment of the invention.

### DETAILED DESCRIPTION OF THE PREFERRED EMBODIMENT

The features, aspects and advantages of the present disclosure will now be described with reference to the drawings of several embodiments which are intended to be within the scope of the embodiments herein disclosed. These and other embodiments will become readily apparent to those skilled in the art from the following detailed description of the embodiments having reference to the attached figures, the development not being limited to any particular embodiment(s) herein disclosed.

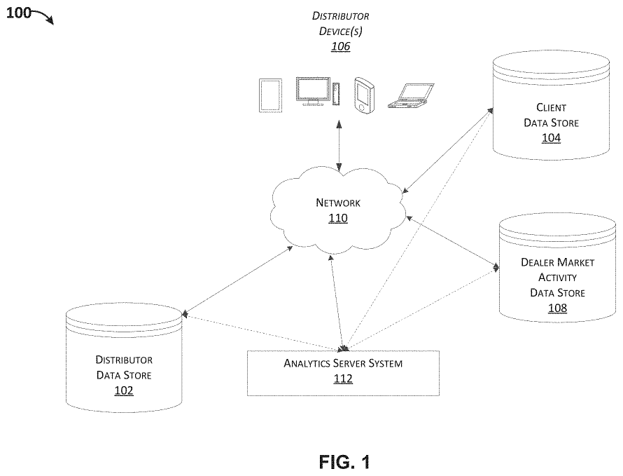

As noted above, FIG. 1 shows a high-level block diagram of a communications system 100 having various network components in accordance with one embodiment of the invention. As used in this disclosure, a distributor generally refers to an entity that obtains or imports products from one or more manufacturer(s) directly or indirectly (e.g., through an intermediary) for distribution to one or more dealer(s). A dealer generally refers to a person or company (i.e., an entity) who obtains or purchases the products from the distributor and ultimately sell(s) the products to one or more consumer clients. The product generally refers refer to any manufactured product, e.g., appliances, cabinetry, equipment, machinery, tools, etc. A contractor may be an electrician, a plumber, a heating and air-conditioning worker, a painter, a carpenter, remodeler, and any other contractor who provides a service or product to a consumer client. In one embodiment, a contractor would contract or sign up for a service for a subscription fee with the operator of the analytics server 112 of FIG. 1. The service may include providing by the operator of the analytics server 112 a variety of contractor services to the contractor, including appointment scheduling, billing, payment, and follow-up, using electronic communications over the communications network 110. In this context, the contractor may operate as a “dealer” entity that purchases or obtains the products to deliver to its customers, e.g., consumer clients.

As shown in FIG. 1, a communications network 110 connects the various network components and is shown as a network cloud that represents any wired and/or wireless network that can be used for communications between two or more communication devices. For instance, the communications network 110 may comprise the public Internet, a private network, a wired network such as a landline based data communications system, a wireless network such as a mobile data network (sometimes referred to as a “cellular” network) or Wi-Fi, or any combination of the foregoing communications networks. The network components shown in FIG. 1 include one or more distributor devices 106 connected to the communications network 110, a distributor data store 102 connected to the communications network 110, a client data store 104 connected to the communications network 110, a dealer activity data store 108 connected to the communications network 110, and an analytics system or server 102 also shown connected to the communications network 110. Each of these network components may be connected to the communications network 110 via an appropriate network connection interface that may be wired (e.g., using an Ethernet connection) and/or wireless (e.g., using a Wi-Fi or mobile data connection).

The analytics server 112 may comprise any computer or system that provides resources, data, services, or programs to other computers, sometimes referred to as client terminals, over the communications network 110, which may include one or more web servers, mail servers, and/or file servers. In addition, the analytics server 112 provides services allowing a dealer who participates in a Dealer Support Program to order and transact business with one or more distributors and clients. In one embodiment, the distributor pays the whole or partial monthly subscription to analytics server 112 in exchange to have access to view the dealer's purchasing from distributor(s) and bidding activities (e.g., proposals) with its clients, e.g., by allowing the dealer to view a dashboard of the company. In one embodiment, the distributor may be allowed to view modules used by Dealer to transact its purchases and proposals with other distributors. For such dealer transactions, the distributor may have access thereto in read only view to avoid any interference in the transactions themselves. The dealer transactions can be stored in cloud servers and/or dealer market activity data store 108, which is described in greater detail below.

In addition, the distributor is able to see total monthly subscription fee(s) that the dealer is due at the end of the month, distributor's payment portion and dealer's payment portion. The analytics server 112 would allow the distributor to share its price list with the dealer and to view certain or limited information about the dealer, such as its active users, name of the dealer. In one embodiment, the analytics server allows the distributor to submit an invite to one or more dealer(s) to participate in the Dealer Support Program, share the distributor's price list, and/or provide other information. All activities and submissions made by the distributor may be generally accomplished using the distributor device 106 over the communications network 110. For instance, an account manager (e.g., an employee) of the distributor may establish an account with the operator of the analytics server 112 to allow dealers or contractors to transact business (e.g., place orders for products from the distributor) online over the communications network 110 using the analytics server 112. In one embodiment, the analytics server 112 permits the distributor to interact with the dealers or contractors via messaging exchanged between them to place, process, and pay for such orders. As noted above, the distributor may provide the analytics server 112 with information needed for transacting such orders with dealers and contractors, such as a price list and payment details, such as distributor's contact information using links and/or electronic forms for the dealer or contractor to fill out to complete the transaction.

In one embodiment, the distributor may send an invitation to a dealer or contractor to join the “Distributor Support Program”, as noted above. The invitation may be in a form of a link to or an actual form that shows up with the ability for the dealer to select a distributor manager who will be responsible for the dealer account. The invitation may also specify the subscription allowance amount (e.g., the whole or a part of the subscription fee) covered by the distributor for the benefit of the invited dealer. The invitation may include prepopulated text or a special text message, which distributor sends to the invited dealer. In addition, the distributor may have multiple pricing tiers or levels depending on the dealer. Thus, the distributor may specify the price list tier or level selected for the invited dealer.

In one embodiment, the distributor can access dealer information using his device 106 over the communications network 110 from the analytics server 112. For instance, the distributor (or a “user” on behalf of the distributor entity) may enter his authentication credentials (e.g., a username and/or password) into a website or an application on his device 106 to access his profile in the analytics server 112. Once authenticated by the analytics server 112, the distributor can view a dealer list. After the distributor accesses the dealer information, the distributor can see the history of orders of the equipment by a particular dealer in this list. Further the distributor can monitor and view proposals submitted by the dealer to allow the distributor to make recommendations to the dealer and/or promote certain products supplied by the distributor. As noted above, the dealer typically would use the analytics server 112 platform to place orders with distributors. The dealer would establish his own account with the operator of the analytics sever 112. By doing so, the dealer would provide its contact and payment information to the analytics server 112 using a communications device of the type described as the distributor device 106. The provided information would be readily available when the dealer conducts transactions with any of the distributors and/or its clients using the analytics server 112. As will be described later in this disclosure, the dealer will be presented with information to monitor the status of the order from the order's first placement, its progress, its shipment to its receipt by the dealer.

As noted above and shown in FIG. 1, the distributor data store 102 communicates with the analytics server 112 directly, or over its connection to the communications network 110, via an appropriate network connection interface that may be wired (e.g., using an Ethernet connection) and/or wireless (e.g., using a or mobile data connection). The data store 102 may comprise any type of computer memory such as one or more magnetic storage device(s) (e.g., hard disk drive), optical storage device(s) (e.g., CI), DVI), and Btu-ray discs), and/or solid state storage device(s) (e.g., SSDs). In one embodiment, the data store 102 is configured to store distributor information, e.g., distributor companies' profiles, for processing subscription information and for authenticating users of distributors. The profile of such distributors may include contact, billing, authenticating data, and/or subscription details, which are entered by the user and/or obtained and processed by the operator of the analytics server 112. As described above, the analytics server 112 authenticates user(s) of distributor device(s) 106 based on the details stored in the distributor data store 102. Once user information is authenticated and subscription information is validated, the analytics server 112 permits access to the user of the distributor device 106 to access other data stores 104 and 108 across the network.

Further, as noted above and shown in FIG. 1, the data store 104 communicates with the analytics server 112 directly, or over its connection to the communications network 110, via an appropriate network connection interface that may be wired (e.g., using an Ethernet connection) and/or wireless (e.g., using a Wi-Fi or mobile data connection). The data store 104 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs), In one embodiment, the data store 104 is configured to store client information for allowing dealers to transact its business with clients using the analytics server 112. As described above, the transactions are entered into the analytics server 112 by a dealer or user via the distributor-type device 106 over the communications network 110. The analytics server 112 coordinates and processes the entered transaction to direct to the intended client(s) for storage in the client data store 104 for the intended client(s). As indicated above, the analytics server 112 also coordinates retrieval of such transaction information for display to an authorized client, dealer, and/or subscriber or user of the distributor device 106.

Further, as noted above and shown in FIG. 1, the dealer market activity data store 108 communicates with the analytics server 112 directly, or over its connection to the communications network 110, via an appropriate network connection interface that may be wired (e.g., using an Ethernet connection) and/or wireless (e.g., using a Wi-Fi or mobile data connection). The data store 108 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). In one embodiment, the data store 108 is configured to store dealer profiles and market information previously described above, such as orders placed, proposals submitted to client(s), and contact information. As indicated above, such dealer information is generally processed by, the analytics server 112. In one embodiment, the analytics server 112 tracks service (or product) orders placed by each dealer entity using information obtained from ordering and bidding activities of each dealer entity with distributors found in the distributor data store 102. In another embodiment, the transaction information with clients about a particular dealer may be initially entered by or obtained from the user of the dealer (e.g., via a device(s) 106), which are then communicated over the communications network 110 to and processed by the analytics server 112 for storage in and retrieval from the dealer activity data store 108. Transaction information is categorized and sorted by each dealer profile in the data store 108.

Although all the data stores 102, 104, and 108 are described above as separate entities communicating with the analytics server 112 over the communications network 110, one or more of the data stores 102, 104, and 108 may be consolidated in a single or multiple co-located data storage device(s) for access by the analytics server 112. Such an alternative configuration may eliminate the need for the communications network 110 to support communication between the data stores 102/104/108 and the analytics server 112. Without the communications network 110, the analytics server 112 communicates with and maintains control of the data stores 102/104/108 directly, i.e., via a direct communication link. In summary, the analytics server 112 coordinates access and exchange of information between the distributor device(s) 106 and the data stores 102, 104, and 108.

Finally, as noted above and shown in FIG. 1, the distributor device(s) 106 communicates with the analytics server 112 over its connection to the communications network 110 via an appropriate network connection interface that may be wired (e.g., using an Ethernet connection) and/or wireless (e.g., using a Wi-Fi or mobile data connection). Each distributor device(s) 106 may comprise any type of mobile or stationary communications device, such as a desktop or laptop personal computer or terminal, a tablet device, a personal data assistant (PDA), a mobile (smart) phone, a kiosk, a smart watch, a car console, a media player, or any other device configured to communicate over the communications network 110 via a wired and/or wireless connection. In one embodiment, the distributor device(s) 106 is configured with a user interface medium, such as an installed web browser or a dedicated application, which permits access to the analytics server 112 via the communications network 110. As described above, a “user” on behalf of the distributor may enter his authentication credentials (e.g., a username and/or password) into the user interface medium on the device 106 to access his profile in the analytics server 112. Once authenticated by the analytics server 112, the user can access his distributor's own profile in the distributor data store 102, client information in the client data store 104, and/or dealer activity information in the dealer activity data store 108, in accordance with the conditions described respectively above. In one embodiment, the dealer activity and/or transactions with clients may be obtained from another independent source. The analytics server 112 coordinates and processes the entered client information for storage in the data store 104 in accordance with a particular client profile. The analytics server 112 also coordinates retrieval of such client information for display to the user of the distributor device 106.

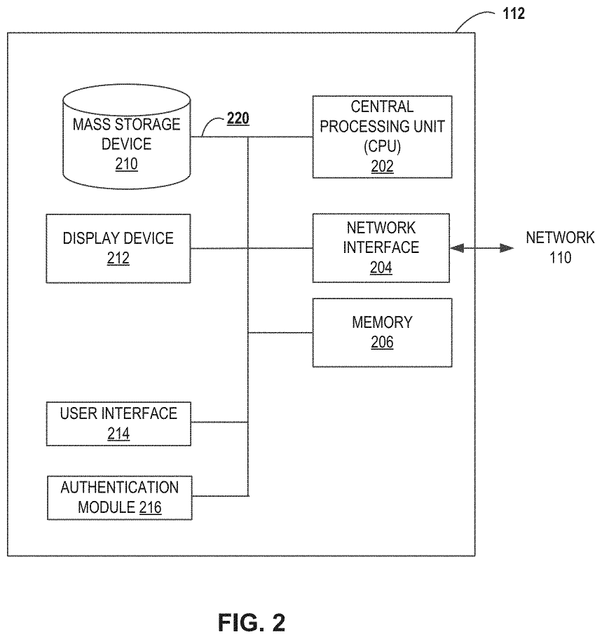

As noted above, FIG. 2 is a functional block diagram of the analytics server 112 of the communications network 100 of FIG. 1. Generally, the analytics server 112 may comprise any computer or system that provides resources, data, services, or programs to other computers, known as clients, over the communications network 110, which may include one or more web servers, mail servers, and/or file servers. In one embodiment, and with reference to FIG. 2, the analytics server 112 comprises a central processing unit (CPU) 202 connected to a physical bus network 220, to which the following physical components/devices are connected: a mass storage device 210, a display device 212, a user interface 214, an authentication module 216, a memory unit 206, and a network interface 204. The CPU 202 may be built into a computer that is IBM, Macintosh, or Linux/Unix model or compatible type, or into a server or workstation or a mobile computing device operating on a suitable operating system. The CPU 202 may control and coordinate operation of all of the foregoing components/devices within the analytics server 112. The CPU 202 may also be referred to as a “processor” or “CPU”, which may comprise or be a component of a processing system implemented with one or more processors. The one or more processors may be implemented with any combination of general-purpose microprocessors, microcontrollers, digital signal processors (“DSPs”), field programmable gate array (“FPGAs”), programmable logic devices (“PLDs”), controllers, state machines, gated logic, discrete hardware components, dedicated hardware finite state machines, or any other suitable entities that can perform calculations or other manipulations of information.

As shown in FIG. 2, the mass storage device 210 and memory unit 206 are two types of storage components that may be found in the analytics sever 112. The memory unit 206 includes one or both of read-only memory (ROM) and random access memory (“RAM”) and may provide instructions and data to the processor 202. For example, data received via inputs received over the communications network 110 by one or more components of the analytics server 112 may be stored in the memory unit 206. A portion of the memory 206 may also include non-volatile random access memory (“NVRAM”). The processor 202 typically performs logical and arithmetic operations based on program instructions stored within the memory 206 in order to perform and achieve the various functions described in connection with the analytics server 112 of FIG. 1 above. The instructions in the memory 206 may be executable to implement the functions of the analytics server 112. In some embodiments, the memory 206 may be configured as a database and may store information that is received via the network interface 204 or the user interface 214.

On the other hand, the mass storage device 210 provides the analytics server 112 with larger storage capacity (compared to the memory unit 206) to accommodate storage for large files and a more permanent storage medium. The mass storage device 210 may also be used to back up all data received or stored in the memory unit 206. The data store 210 may comprise any type of computer memory such as one or more magnetic storage device(s) (e.g., hard disk drive), optical storage device(s) (e.g., CD, DVD, and Btu-ray discs), and/or solid state storage device(s) (e.g., SSDs). The mass storage device 210 may store software or machine instructions for allowing the CPU to process many of the subscriptions, authentication, and dealer market activity information described in connection with FIG. 1 above. Software generally refers to any type of instructions, whether referred to as software, firmware, middleware, microcode, hardware description language, or otherwise. Instructions may include code (for example, in source code format, binary code format, executable code format, or any other suitable format of code), The instructions, when executed by the one or more processors, cause the processing system to perform the various functions described herein. Accordingly, the analytics server 112 includes, for example, hardware and firmware and/or software, or any combination thereof.

The user interface 214 may comprise a keypad, a microphone, a touchpad, a speaker, and/or a touch display, or any other commonly available input/output (“I/O”) devices and interfaces. The user interface 214 may include any element or component that conveys information from the operator of the analytics server 112 to the analytics server 112. In one embodiment, the display device 212 may be combined with or be separate from the user interface 214 and may include one or more display devices, such as a monitor, that allows the visual presentation of data to the operator of the analytics server 112. More particularly, the display device provides for the presentation of GUIs, application software data, websites, web apps, and multimedia presentations, for example.

The network interface 204 provides a communication interface to various external devices directly or over the communications network 110. For example, the analytics server 112 is electronically coupled to the communications network 110 (FIG. 2A), which comprises one or more of a LAN, WAN, and/or the Internet. Accordingly, the network interface 204 includes an interface allowing for communication with the communications network 110, for example, via a wired communication port such as Ethernet, telephone connection; cable television or wired internet access, and/or fiber-optic communication; a wireless communication port, or a combination of both.

In one embodiment, the authentication module 216 comprises a dedicated processor or may be combined within the CPU 202. As described in connection with FIG. 1 above, the authentication module 216 performs the authentication functions of subscriber distributors and dealers who sign up (or already signed up) for accessing and receiving the services offered by the analytics server 112. For example, the distributor (or a “user” on behalf of the distributor entity) may enter his authentication credentials (e.g., a username and/or password) into a website or an application on his device 106 to access his profile in the analytics server 112. The authentication module 216 authenticates the entered credentials and, if the credentials pass, the distributor can view a dealer's available transaction activity with clients and other distributors as described in connection with FIG. 1 above.

As noted above, communications between the various components or devices within the analytics server 112 are exchanged over the bus network 220. The bus network 220 may include a data bus, for example, as well as a power bus, a control signal bus, and a status signal bus in addition to the data bus. The bus network 220 may be implemented in Peripheral Component Interconnect (“PCI”), Microchannel, Small Computer System Interface (“SCSI”), Industrial Standard Architecture (“ISA”), and/or Extended (“EISA”) architectures, for example. Finally, the functionality provided in the components and devices of the analytics server 112 may be combined into fewer components and devices or further separated into additional components and modules than that shown in FIG. 2.

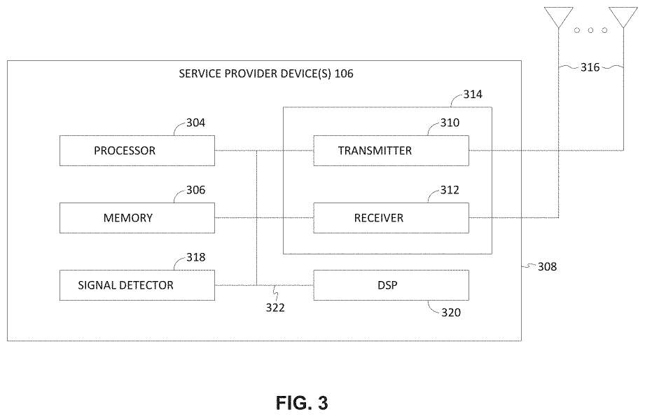

FIG. 3 is a functional block diagram of an exemplary distributor device 106 of the communications network 110 of FIG. The distributor device 106 is an example of a device that may be configured to implement the functions described in connection with the interaction of the user (on behalf of the distributor entity) with the analytics server 112 described in connection with FIG. 1 above. The distributor device 106 may comprise a processor 304 which controls operation of the distributor device 106. In addition to the processor 304, the distributor device 106 comprises a memory 306, which may include both read-only memory (ROM) and random access memory (RAM), provides instructions and data to the processor 304. A portion of the memory 306 may also include non-volatile random access memory (NVRAM). The processor 304 may perform logical and arithmetic operations based on program instructions stored within the memory 306. The instructions in the memory 306 may be executable to implement the functions of the distributor device 106 described above. As shown in FIG. 3, the processor 304 and memory 306 are connected to a physical bus system 322 (similar in function and structure to the bus system 220 of FIG. 2) to exchange communication messages and instructions. The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The distributor device 106 may also comprise a housing 308 that may include a transmitter 310 and a receiver 312 to provide respective transmission and reception of data between the distributor device 106 and the analytics server 112 over the communications network 110. The transmitter 310 and receiver 312 may be combined into a transceiver 314. A single or a plurality of transceiver antennas 316 may be attached to or integrated within the housing 308 and electrically coupled to the transceiver 314. The antennas 316 are provided to allow communications over a wireless medium, such as those accommodating data communication, including and/or cellular data channels. In an embodiment where the distributor device 106 interfaces with the communications network 110 over a wired medium, the antennas 316 would be replaced with or added to a wired interface such as Ethernet, telephone connection, cable television or wired internet access, and/or fiber-optic communication. The distributor device 106 may also comprise multiple transmitters, multiple receivers, and multiple transceivers (not shown in this figure) to accommodate compatible communications with the communications network 110 and other devices (not shown in this figure). As shown in FIG. 3, each of the transmitter 310 and receiver 312 is connected to the bus system 322 to exchange messages and data with the processor 304, memory 306, and other components within the distributor device 106.

The distributor device 106 may also comprise a signal detector 318 that may be used to detect and quantify the level of signals received by the receiver 312. The signal detector 318 may detect such signals as total energy, energy per subcarrier per symbol, power spectral density and other signals. The distributor device 106 may also include a digital signal processor (DSP) 320 for use in processing incoming and outgoing communication signals, e.g., to confirm the communication signals to suitable or compliant communication protocols. The signal detector 318 may determine if the received signals are of sufficient strength for processing by the DSP 320.

The various components of the wireless communication device 302 may be coupled together by the bus system 322, which may include a power bus, a control signal bus, and a status signal bus in addition to a data bus.

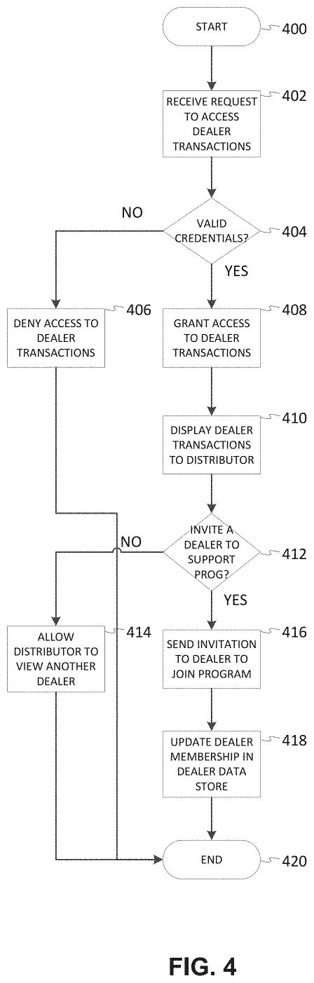

As noted above, FIG. 4 is a flowchart of an exemplary process of accessing information about dealer market transactions in accordance with one embodiment of the invention. The process begins at block 400. At block 402, the analytics server 112 receives a login request for authentication of a user of a distributor device 106. As described above, a “user” on behalf of the distributor entity may enter his authentication credentials (e.g., a username and/or password) into a website or an application on his device 106 to access his profile in the analytics server 112. If at decision block 404 the analytics server 112 fails to validate the authentication credentials of the user, the analytics server 112 would (at block 406) deny access to the client data store 104. If at the decision block 404 the analytics server validates the authentication credentials of the user, the analytics server 112 would (at block 408) grant access to the client data store 104. Once authenticated by the analytics server 112, the analytics server 112 grants the user with access at block 408 to view a dealer list with available transactions. As described above, the analytics server 112 displays available transactions to the user at block 410, which may include detailed equipment order form for distributor to view. The form may be synchronized “live” (e.g., instantaneously) with the form being used by the dealer when viewed by the dealer. With this live view, the distributor is ensured to look at the most up to date order(s) transacted by the dealer. The equipment order form allows the dealer to place an order for products with the option to select distributor, items needed for the order, target date and time (when equipment is needed), order type, delivery destination (e.g., to dealer location, job site, or another custom location), and pick up (distributors warehouse or dealers shop). The form has a simple drag and drop of items between the orders if the order is in a “new order” status. At decision block 412, the analytics server 112 determines if the distributor wishes to invite a dealer to join the “Distributor Support Program”, noted above whereby the distributor can incentivize the dealer to join by sharing or fully covering the dealer fee to conduct its order transactions using the analytics server 112.

If the distributor does not wish to invite a particular dealer to the distributor support program, then the analytics server 112 would allow the distributor to view another dealer for action at block 414. It is worth noting that the process may include other steps not depicted in this figure, or skip this step or other steps shown in this figure. As described above, the distributor may view the other dealer or dealers to initiate invitations to join the program or review transactions being done between the distributor and the dealer. If at block 412 the analytics server 112 determines that the distributor wishes to invite the selected dealer, the analytics server 112 allows the distributor at block 416 to initiate sending an invitation to the selected dealer to join the distributor support program. At block 418, the analytics server 112 updates the dealer data store 104 with any new and/or accepted invitations and processes membership and payments etc. The process ends at block 420.

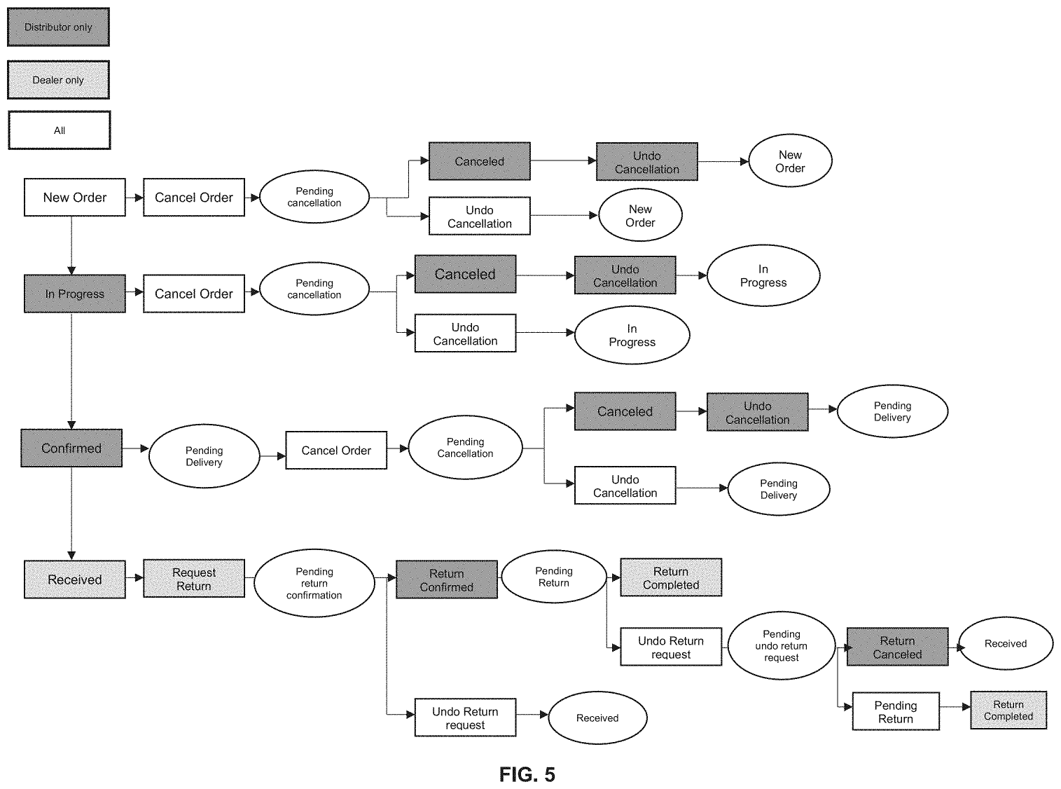

FIG. 5 is a flowchart describing a process of placing and monitoring progress of an order in accordance with one embodiment of the invention. This figure is intended to show the various steps and actions that can be taken by the distributor and/or dealer when transacting an order for product(s) between them. As shown in FIG. 5, there are four horizontally extended flow charts. In the first flow chart (from the top), a new order can be placed by either the distributor (e.g., on behalf of the dealer) or by the dealer. Going from left to right along the first flow chart, either the distributor or dealer may cancel the order along the path of the first flow chart. After a period of pending cancellation, the distributor may cancel the order and declare it “cancelled”, or either the distributor or dealer may undo cancellation and convert the cancelled order into a new order again, as shown at the end (right hand side) of the first flow chart.

If on the other hand, the new order is not canceled then the new order goes into “In Progress” status. While in progress, the order follows the progress shown in the second flow chart (from left to right). If the order follows the second flow chart, the order may be cancelled or undo cancelation in a manner very similar to that described in the first flow chart above. If none of the distributor or dealer subjects the order to the second flow chart, then the order transitions from “In Progress” to “Confirmed” status. While in the “Confirmed” status, the order transitions to a “pending delivery” state with the option to proceed along a third flow chart. If either the distributor or dealer subjects the order to a cancellation, the order can be either cancelled or un-cancelled. If cancelled as shown along the third flow chart, the order is terminated. If un-cancelled as shown along the third flow chart, the order transitions back to “pending delivery” status. After “pending status”, the order transitions to “Received” status. As shown in FIG. 5, the order status proceeds along the fourth flow chart (bottom and from left to right of FIG. 5), whereby the dealer has the option to “request return” of the order whereby the order status transitions to “pending return confirmation” status. After the foregoing status, the distributor has the option to confirm the return and transition the status of the order to “Return Confirmed” status. Both the distributor or dealer can undo the return request and, if so, the order status goes back to “Received” status. If on the other hand, if the neither distributor nor dealer undoes the return request, then the return request can remain in confirmed or pending status until the return is completed.

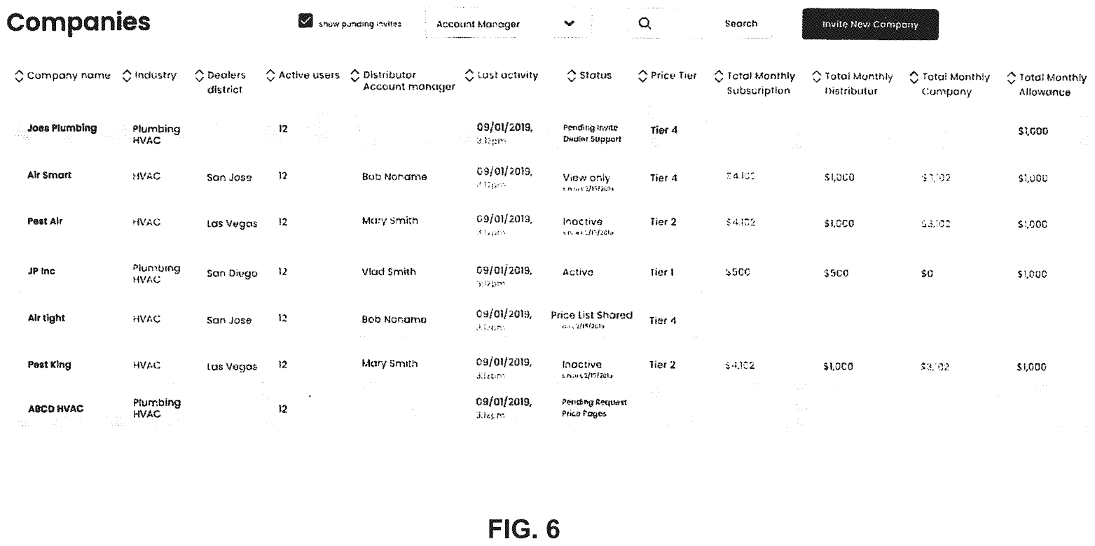

As noted above, FIG. 6 shows a screenshot of an exemplary page of a list of dealer entities associated with a distributor in accordance with one embodiment of the invention. As described in connection with FIGS. 1-4 above, a distributor can identify and view a list of dealer companies related to (e.g., transact business with) the distributor. In this instance, FIG. 6 shows twelve columns with the following headings: Company name, Industry, Dealers district, Active users, Distributor Account manager, Last activity, Status, Price Tier, Total Monthly Subscription, Total Monthly Distributor, Totally Monthly Company, and Total Monthly Allowance. As used in this screenshot, the term “company” generally refers to the “dealer” company. In this example, the screenshot shows a list of seven companies in the first (from left to right) column under the Company name. Most of the headings for the columns are in this screenshot are self-explanatory. For instance, the dealer district column refers to the geographical location (e.g., city or county) where the dealer entity is located. The price tier column represents the level of pricing (e.g., by distributor price list) that the dealer company may use when ordering product(s) from the distributor. As described above, the analytics server 112 would allow the distributor to share its price list with the dealer and to view certain or limited information about the dealer, such as its active users, name of the dealer. In the distributor account manager column, an account manager (e.g., an employee) name of the distributor is shown as one who responsible for the dealer entity, e.g., may establish an account with the operator of the analytics server 112 to allow the dealer subscribe and to transact business (e.g., place orders for products from the distributor) online over the communications network 110 using the analytics server 112. The total monthly subscription column shows the fee charged by the operator of the analytics server 112 for the Distributor Support Program subscription, followed by the portion of the fee paid by the distributor (shown in total monthly distributor column) and by the portion of the tee paid by the dealer (shown in the total monthly company column). Thus, as described above, the distributor is able to see total monthly subscription fee(s) that the dealer is due at the end of the month, distributor's payment portion and dealer's payment portion.

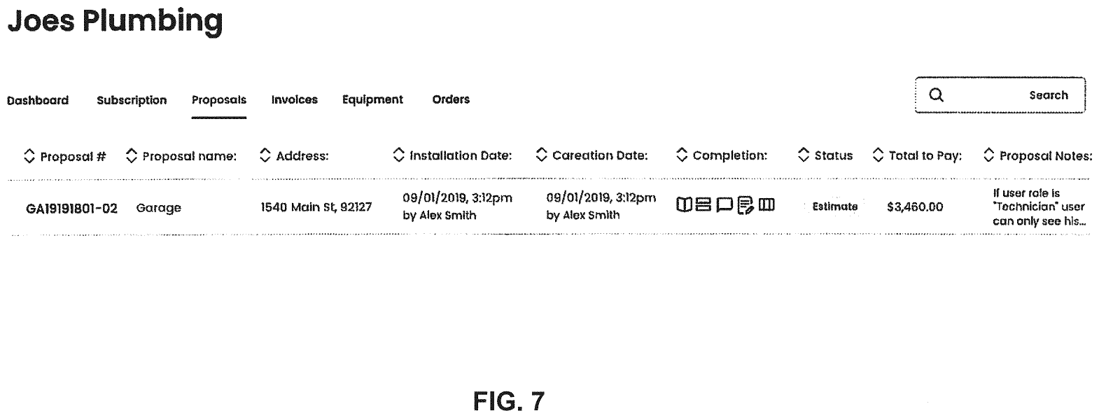

FIG. 7 is a screenshot of an exemplary page showing sample proposal(s) of a dealer entity in accordance with one embodiment of the invention. As shown in FIG. 7, nine columns are recited with the following headings: Proposal No., Proposal name, Address, Installation Date, Creation Date, Completion, Status, Total to Pay, and Proposal Notes. There is a “proposal” tab on top of the shown page that leads to this screen to allow the distributor to view proposal(s) of the dealer entity (that participates in the distributor support program). In one embodiment, the distributor can see sales activity of dealer in a live view mode. The dealer proposal activity may be quite valuable to the distributor to monitor its own likelihood of selling and to promote the selling of its own goods based on the dealer's proposal activity.

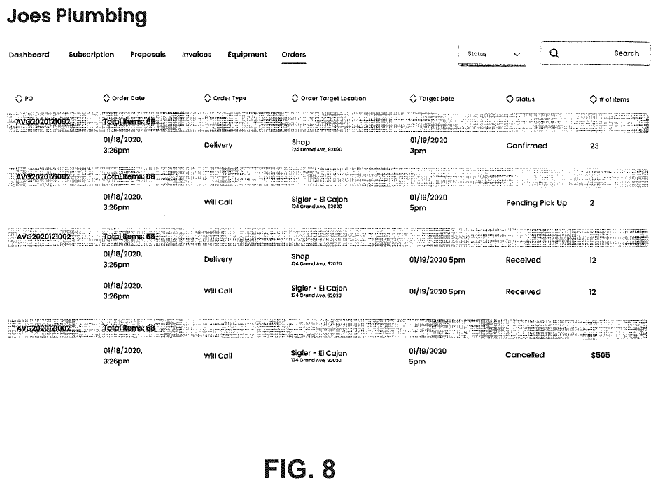

FIG. 8 is a screenshot of an exemplary page showing sample order history made by a dealer entity in accordance with one embodiment of the invention. As shown in FIG. 8, seven columns are provided with the following headings: PO (Purchase Order No.), Order Date, Order Type, Order Target Location, Target Date, Status, and Number of Items in the order. As described in connection with FIGS. 1-4, the distributor is able to see the history of orders of equipment made by the dealer of interest in this section. The order history and details thereof are gathered and processed by the analytics server 112 as described above.

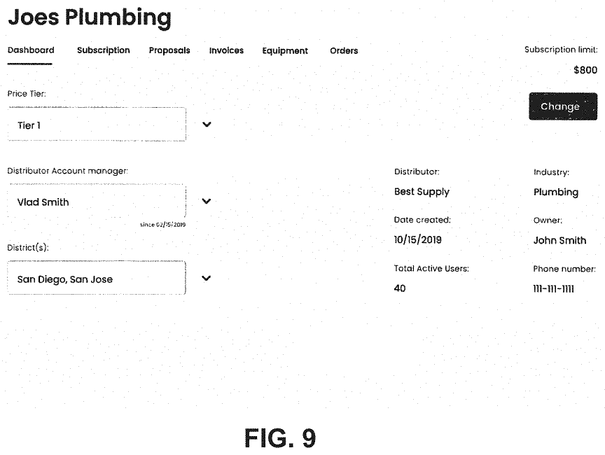

FIG. 9 is a screenshot of an exemplary page showing a sample request for a price list initiated by a dealer entity to a distributor in accordance with one embodiment of the invention. The screenshot shows a request form for requesting a price list from a distributor. This form is typically completed and initiated by the dealer to the distributor. As shown in IG. 9, there are three drop down menus in this example for identifying or selecting a Price Tier, Distributor Accounting Manager, and the District(s) in which the dealer is located. The form identifies pertinent information about the dealer entity, such as owner (e.g., John Smith), industry (e.g., Plumbing), and phone number. In response to receiving the request for the price list from the dealer, the distributor has an option to accept the request and select the price tier (from the drop down menu) to share with the requesting dealer. Alternatively, the distributor has the option to simply decline the request for the price list made by the requesting dealer. As noted above, this entire price list exchange occurs using the analytics server 112 whereby the distributor and dealer can communicate over the communications network 110.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof. Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable devices that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some, or all, of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language such as, among others, “can,” “could,” “might” or “may,” unless specifically stated otherwise, are otherwise understood within the context as used in general to convey that certain embodiments include, while other embodiments do not include, certain features, elements and/or blocks. Thus, such conditional language is not generally intended to imply that features, elements and/or blocks are in any way required for one or more embodiments or that one or more embodiments necessarily include logic for deciding, with or without user input or prompting, whether these features, elements and/or blocks are included or are to be performed in any particular embodiment.

Disjunctive language such as the phrase “at least one of X, Y, or Z,” unless specifically stated otherwise, is otherwise understood with the context as used in general to present that an item, term, and so forth, may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following.

What is claimed is:

1. A system for providing information about one or more dealers to a distributor, the system comprising:
a hardware processor configured to obtain dealer information via a dealer communications device over a communications network, the dealer information being based on purchasing activity between the dealer and one or more distributors other than the distributor; and
a memory device in communication with the hardware processor and configured to store the dealer information for later retrieval by the hardware processor, wherein the hardware processor is further configured to authenticate the distributor based on credentials provided by the distributor and, if the hardware processor determines that the credentials are valid, permit access by the distributor to view the dealer information.

2. The system of claim 1, wherein the communications network comprises a wired and/or wireless network.

3. The system of claim 1, wherein the hardware processor is further configured to send an invitation initiated by the distributor to the dealer to permit the distributor to view the dealer information in a read-only mode.

4. The system of claim 3, wherein the hardware processor is further configured to determine that the dealer has accepted the invitation initiated by the distributor and update dealer status to a member of distributor support program in a dealer data storage device.

5. The system of claim 1, wherein the hardware processor is configured to process transactions of the purchasing activity between the dealer and the one or more distributors over the communications network.

6. The system of claim 1, wherein the hardware processor is configured to control storage of and access by the distributor to the dealer information in the memory device over a wired and/or wireless network.

7. The system of claim 1, wherein the memory device comprises a first data storage device for storing information about the one or more distributors and a second data storage device for storing information about the dealer.

8. The system of claim 1, wherein the purchasing activity comprises equipment purchases made and/or proposals submitted by the dealer.

9. The system of claim 1, wherein the hardware processor comprises a web server configured to interact with the distributor and the dealer via a web or dedicated application installed in a communications device accessible by the distributor and the dealer, respectively.

10. The system of claim 1, wherein the hardware processor is further configured to seek verification from the dealer before permitting access by the distributor to view the dealer information.

11. A method of providing information about one or more dealers to a distributor, the method comprising:
obtaining by a hardware processor dealer information via a dealer communications device over a communications network, the dealer information being based on purchasing activity between the dealer and one or more distributors other than the distributor; and
storing in a memory device the dealer information for later retrieval by the hardware processor;
authenticating the distributor based on credentials provided by the distributor; and
if the hardware processor determines that the credentials are valid, permitting access by the distributor to view the dealer information.

12. The method of claim 11, wherein the communications network comprises a wired and/or wireless network.

13. The method of claim 11, further comprising sending an invitation initiated by the distributor to the dealer to permit the distributor to view the dealer information in a read-only mode.

14. The method of claim 13, further comprising determining that the dealer has accepted the invitation initiated by the distributor and updating dealer status to a member of distributor support program in a dealer data storage device.

15. The method of claim 11, further comprising processing transactions of the purchasing activity between the dealer and the one or more distributors over the communications network.

16. The method of claim 11, further comprising controlling storage of and access by the distributor to the dealer information in the memory device over a wired and/or wireless network.

17. The method of claim 11, wherein the memory device comprises a first data storage device for storing information about the one or more distributors and a second data storage device for storing information about the dealer.

18. The method of claim 11, wherein the purchasing activity comprises equipment purchases made and/or proposals submitted by the dealer.

19. The method of claim 11, wherein the hardware processor comprises a web server configured to interact with the distributor and the dealer via a web or dedicated application installed in a communications device accessible by the distributor and the dealer, respectively.

20. The method of claim 11, further comprising seeking verification from the dealer before permitting access by the distributor to view the dealer information.
